(19) United States
(12) Patent Application Publication
(10) Pub. No.: US 2024/0134614 A1
(43) Pub. Date: Apr. 25, 2024

(54) SOURCE CODE PATCH GENERATION WITH RETRIEVAL-AUGMENTED TRANSFORMER

(71) Applicant: MICROSOFT TECHNOLOGY LICENSING, LLC., Redmond, WA (US)

(72) Inventors: AMANDEEP SINGH BAKSHI, WEST LAFAYETTE, IN (US); XIN SHI, KIRKLAND, WA (US); NEELAKANTAN SUNDARESAN, BELLEVUE, WA (US); ALEXEY SVYATKOVSKIY, BELLEVUE, WA (US)

(21) Appl. No.: 17/966,572

(22) Filed: Oct. 14, 2022

(51) Int. Cl. G06F 8/36; G06F 8/65; G06F 11/36

(52) U.S. Cl. CPC G06F 8/36; G06F 8/65; G06F 11/362

(57) ABSTRACT

A source code patch generation system uses the context of a buggy source code snippet of a source code program and a hint to predict a source code segment that repairs the buggy source code snippet. The hint is a source code segment that is semantically-similar to the buggy source code snippet where the similarity is based on a context of the buggy source code snippet. An autoregressive deep learning model uses the context of the buggy source code snippet and the hint to predict the most likely source code segment to repair the buggy source code snippet.

### BACKGROUND

As software becomes more complex, it is inevitable that the number of software bugs will increase rapidly. A software bug is an error or defect in a source code program that causes the program to behave in an unexpected way or produce an erroneous or unexpected result. Software bugs hinder the development of a software program since the detection of a software bug may consume a significant amount of time to detect, especially when the location of the software bug is unknown. No matter how rigorous the program is tested, a software bug may go undetected and create disastrous results if left unresolved.

Large language models have been used to support or automate the tasks of identification, classification and repair of software bugs. These large language models typically consist of billions of parameters requiring a significant amount of computing resources to train. At times, the size of these models hampers the development of these models and their implementation in systems with limited computing resources.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

A source code patch generation system uses the context of a buggy source code snippet having a known bug type and a hint to predict source code that repairs the buggy source code snippet. The hint is a source code segment known to have repaired another buggy source code snippet having the same bug type and which is closely similar to the context of the buggy source code snippet. The hint and the context of the buggy source code snippet is then used by a neural transformer model with attention to predict the most likely source code to repair the buggy source code snippet.

The hint is a semantically-similar source code segment to the buggy source code snippet that has the same bug type. The semantically-similar source code segment is retrieved from a database using a hybrid retrieval technique. The database contains source code segments known to have been repaired from bugs having the same bug type. The source code segments are indexed through an embedding vector index and a sparse vector index. The embedding vector index is generated from a neural encoder based on the context of the source code segment and the sparse vector index is generated from a term-frequency encoder also based on the context of the source code segment. In an aspect, the context of the source code segment includes a bug type annotation, an extended context, focal and peer methods, and the method containing the software bug with location markers delineating the bug.

These and other features and advantages will be apparent from a reading of the following detailed description and a review of the associated drawings. It is to be understood that both the foregoing general description and the following detailed description are explanatory only and are not restrictive of aspects as claimed.

### BRIEF DESCRIPTION OF DRAWINGS

FIG. 1 is a schematic diagram illustrating an exemplary configuration of an offline processing phase for the generation of the repaired source code database.

FIG. 2 is a schematic diagram illustrating an exemplary context of a source code method having a bug and an exemplary input sequence to the neural decoder transformer model for the source code method having the bug.

FIG. 3 is a schematic diagram illustrating an exemplary configuration of the source code patch generation system.

FIG. 4 is a schematic diagram illustrating an exemplary architecture of the neural encoder transformer model with attention.

FIG. 5 is a schematic diagram illustrating an exemplary architecture of the neural decoder transformer model with attention.

FIG. 6 is a flow diagram illustrating an exemplary method for configuring the components of the source code patch generation system.

FIG. 7 is a flow diagram illustrating an exemplary method of the usage of the source code patch generation system.

FIG. 8 is a block diagram illustrating an exemplary operating environment.

### DETAILED DESCRIPTION

### Overview

Aspects of the present disclosure pertain to an automated software bug repair system that predicts source code segments to repair a source code snippet having a known bug and its bug type. The system utilizes a deep learning model to predict the most likely source code segment to repair the buggy source code snippet (e.g., method, expression, statement, etc.) The deep learning model utilizes a context of the buggy source code segment and a hint. The hint is retrieved from a database of repaired source code segments known to have repaired other source code snippets having the same bug type. The hint is a repaired source code segment having the closest similar context and bug type to the context of the source code snippet having a bug.

The use of the hint aids an autoregressive deep learning model towards predicting the most relevant candidates to repair the buggy source code. The autoregressive deep learning model is able to make accurate predictions without requiring the costly and extensive training needed to learn from a large training dataset. Training on a large training data increases the number of parameters used by the model to achieve a higher level of accuracy. This increases the size of the model and the computing resources needed to train and utilize the model.

The database is indexed by an embedding vector and a sparse vector. The embedding vector is generated by an encoder based on the context of the source code segment and the sparse vector index is generated from a term-frequency encoder based on the context of the source code segment. A hybrid retriever is used to search for a source code segment from the database that has the closest semantic similarity to the context of the buggy source code snippet. The hybrid retriever uses a sparse vector based on a term-frequency encoding and an embedding vector index based on a neural encoding. The hybrid retriever computes a score for each source code segment in the database having the same bug type. The score is based on the similarity of the sparse vector and the similarity of the embedding vector to the context of buggy source code. The source code segment having the highest score is deemed the closest semantically-similar source code segment.

The use of the hybrid encodings, embedding vector and sparse vector, to search for the semantically-similar source code segment produces better results. The sparse vector is based on a term-frequency based retrieval technique that captures lexical information. The encoder captures syntactic and semantic information. The retriever is expected to comprehend the intent of the source code context in order to retrieve semantically-similar source code. Lexical similarity refers to the use of the same tokens although not in the same syntax. The use of the hybrid retriever combines results of both retrieval methods to account for semantic similarity that may come from lexical similarity and similar functionality.

In addition, this approach uses a non-parametric external memory or indices to search for the code that repairs the semantically-similar source code snippet. The addition of the non-parametric external memory enables the model to achieve a high-level of accuracy with a relatively small number of parameters and hence, smaller-sized model. The smaller-sized model consumes fewer computing resources to operate thereby making it more amenable to a system with limited computing resources.

Attention now turns to a more detailed description of the components, methods, processes, and system for source code patch generation.

### System

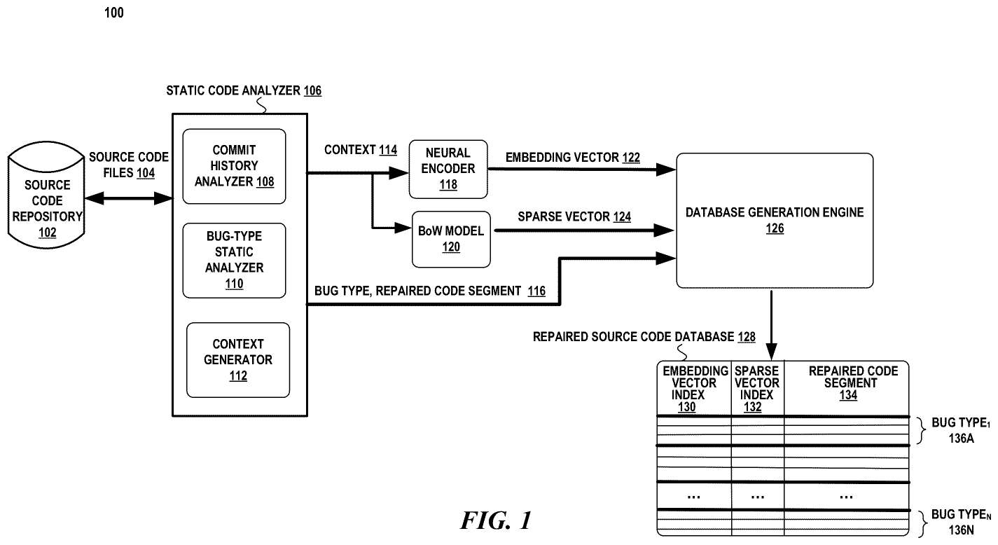

FIG. 1 illustrates a block diagram of an exemplary system 100 in which various aspects of the invention may be practiced. In particular, FIG. 1 shows the components used to generate the repaired source code database 128 which includes one or more source code repositories 102, a static code analyzer 106, a neural encoder 118, a term-frequency model (e.g., Bag-of-Words model) 120, a database generation engine 126 and the repaired source code database 128. The repaired source code database 128 includes source code segments known to have been used to repair a source code bug of a particular bug type. The database is partitioned by bug type 136a-136n and stores the repaired source code segments in a partition that matches the bug type of the repaired source code segment.

The database 128 is indexed by an embedding vector index 130 and a sparse vector index 132. The embedding vector index 130 is an encoding of the context of the source code segment which is generated by the neural encoder 118. In one aspect, the neural encoder 118 is a neural encoder transformer model with attention. The sparse vector index 132 is generated from a Bag-of-Words (“BoW”) model 124 based on a context 114. The generation of the database and the training of the neural encoder and Bag-of-Words model are offline processes that are performed prior to the deployment of these components in a real-time source code patch generation system.

In other aspects, the neural encoder and/or BoW model include a dense vector representation based on latent semantic analysis or a graph-based recurrent retriever that includes external structured information.

The repaired source code segments stored in the database are extracted from one or more source code repositories 102. A source code repository 102 may be a file archive and web hosting facility that stores large amounts of source code either privately or publicly. A source code repository 102 can be structured as a version control system, such as GIT, Mercurial, etc. The source code repository 102 may be a project or directory storing a particular collection of source code files. The source code files residing in the source code repository 102 vary and may be written in different programming languages. The selected source code files can come from different domains, such as without limitation, scientific computing, web development, dataflow programming, machine learning, and the like.

A static code analyzer 106 is used to extract select source code segments from the source code repository 102 having a known bug repair. The source code segments may be a method, class, expression, method invocation, or other type of source code element. The static code analyzer 106 includes a commit history analyzer 108, a bug type static analyzer 110, and a context generator 112. The commit history analyzer 108 scans the commit histories of several source code repositories to find commits pertaining to source code having been changed for a software bug. A commit is an operation that checks a modified version of the source code file back to the source code repository.

The bug-type static analyzer 110 scans each of the source code programs identified by the commit history analyzer 108 to identify the source code bugs in the program. The bug-type static analyzer 110 analyzes a source code program without executing the source code to find software bugs. The bug-type static analyzer 110 differs from a compiler that checks for syntax errors.

Examples of the bug-type static analyzer 110 include, without limitation, Facebook®'s Infer, SpotBugs, Synopsys®'s Coverity, Clang, CodeQP, GitHub's CodeQL, etc. It should be noted that although the techniques disclosed herein refer to Infer, this disclosure is not limited to Infer and that other bug-type static code analyzers may be used.

Infer is an interprocedural code analyzer. An intraprocedural analysis is performed within a method, otherwise referred to as a procedure or function. An interprocedural analysis spans multiple files or methods, including all the methods in the entire program. An interprocedural static code analysis is able to detect memory safety faults that span multiple files or methods, such as null pointer dereferencing and memory leaks, which would be missed if intraprocedural static analysis were used.

Null pointer dereference occurs when the program dereferences a pointer that it expects to be valid, but is null, or points to memory that has not been allocated. Null pointer dereferences typically cause the program to crash or exit. A memory leak occurs when a program allocates memory without ever releasing it. Eventually, the program will exhaust all the available memory and crash when the program attempts to allocate additional memory.

In addition, Infer can detect other issues such as the following: annotation reachability; biabduction; buffer overruns; config checks between markers; eradicate, fragment retains view; immutable cast; impurity; inefficient keyset iterator; loop hoisting; self in block; starvation; topl; and uninitialized variables.

Infer is based on separation logic that performs Hoare-logic reasoning about programs that mutate data structures. Infer uses the analysis language, Smallfoot Intermediate Language (SIL), to represent a program in a simpler instruction set that describes the program's actions on a symbolic heap. Infer symbolically executes the SIL commands over a symbolic heap according to a set of separation logic proof rules in order to discover program paths with the symbolic heap that violate heap-based properties.

It should be noted that SIL differs from intermediate languages, such as bytecodes or Microsoft®'s Common Intermediate Language (CIL), that represent instructions that can be transformed into native code. SIL instructions are used for a symbolic execution which is a logic-based proof analysis. The SIL instructions are not constructed to be executed on a processor or CPU such as the CIL instructions.

The bug-type static code analyzer 110 generates results that identify each source code bug, the location of each source code bug in the program, the bug type, and the commit history associated with the bug, such as when the bug was introduced or fixed. From the commit history, the bug-type static code analyzer can extract the source code having the bug and the analyzer source code that was used to repair the bug or the repaired code.

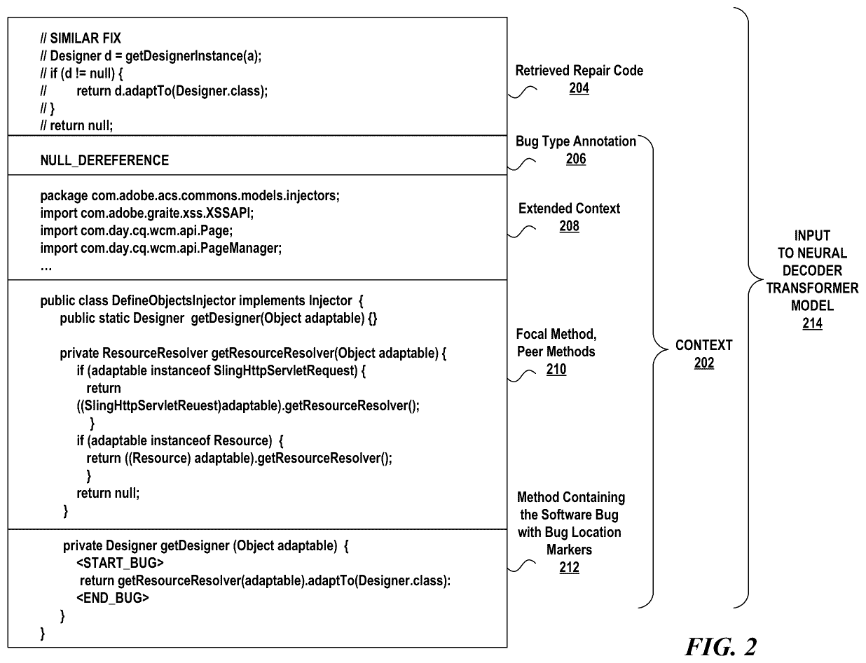

In addition, the context generator 112 generates the context of a particular source code bug in a program. Turning to FIG. 2, there is shown an exemplary context for a source code program having a software bug 202. The context contains a bug type annotation 206, an extended context 208, the focal and/or peer methods 210, and the method containing the software bug with bug location markers surrounding the software bug 212. It should be noted that the context may include other source code elements and a different syntax hierarchy prioritization.

Neural transformers utilize a fixed-size context window of data to train the transformer to learn patterns to make predictions. The fixed-size context window sets how far back in the source code program the model looks to find predictive patterns. Often, the context includes source code within a close range of a target focus. Instead of increasing the size of the context window to cover more context, the context window contains prioritized code elements that extend beyond the target focus in order to provide a longer visibility back into the source code program for the model to learn the predictive patterns. In this manner, the model is given a longer view back into the context of the source code program without increasing the size of the context window. This longer view back into the source code program is considered the extended context.

A priority list is used to indicate the order of the syntax elements that form the context window. A syntax element is a construct in the programming language of a source code program. The syntax hierarchy of the priority list places certain elements in a program over other elements and may include elements of the source code program that are part of the local scope of another method in the program.

The term scope or lexical scope used in computer science refers to the part of the source code program where the binding of a name to an element (variable, method, constant, etc.) is defined. A local scope refers to when an element is defined within a method or function where it is used and a global scope refers to when an element is defined outside of the method where it is used. Syntax elements of other scopes, such as a method or class defined outside of a focal method, may be included in the context of a focal method if used within the focal method or related to the focal method, such as being of a peer class to the focal method or being part of the same class as the focal method. The focal method is the method containing the software bug.

In one aspect, an exemplary syntax hierarchy includes the following prioritized order of syntax elements that encompass an extended context for a focal method: (1) method signature, docstring, and body of the focal method, if any, (2) signature of the class containing a buggy method, (3) import statements and global attributes, (4) signatures of the peer methods, and (5) class members and attributes in class scope.

As shown in the FIG. 2, the context includes a bug type annotation 206, NULL_DEREFERENCE, which is a string providing information about the bug type. The extended context 208 includes syntax hierarchies most relevant to learning to repair bugs.

Returning back to FIG. 1, the context is encoded into an embedding vector 122 using a neural encoder transformer model with attention 118 and into a sparse vector 124 using the BoW model 120. The embedding vector 122 and the sparse vector 124 each form an index into the database for the repaired code segment.

The Bag-of-Words model 120 describes the frequency of the unique source code tokens used in the repaired code segment that is included in the database 128. The Bag-of-Words model 120 is trained on the repaired source code segments 134 in the database 128 in order to develop a vocabulary of unique source code tokens. In an aspect, the vocabulary includes n-grams or n-token sequences of source code tokens. The Bag-of-Words model 120 includes the frequency of each n-gram token over all the n-gram tokens in the database 128.

The Bag-of-Words model 120 is used to create a sparse vector 124 for each repaired code segment 134 in the database 128 that describes the frequency of each n-gram in the repaired code segment. The sparse vector 124 is then used as an index to access a repaired code segment 128. The Bag-of-Words model 120 is also used to generate the sparse vector for the buggy source code snippet that is used to search for a semantically-similar repaired code segment.

The neural encoder 118 is trained to generate an embedding space such that source code segments with similar or equivalent semantics have close embeddings and dissimilar source code segments have embeddings that are far apart. The embedding space includes the encodings or embeddings of each repaired code segment in the retrieval source code database based on their respective context.

The database generation engine 126 receives the embedding vector, sparse vector, bug type, and repaired code segment and generates an entry for the repaired code segment in the partition of the database corresponding to its bug type. The embedding vector and the sparse vector are inserted as indices for the repaired code segment.

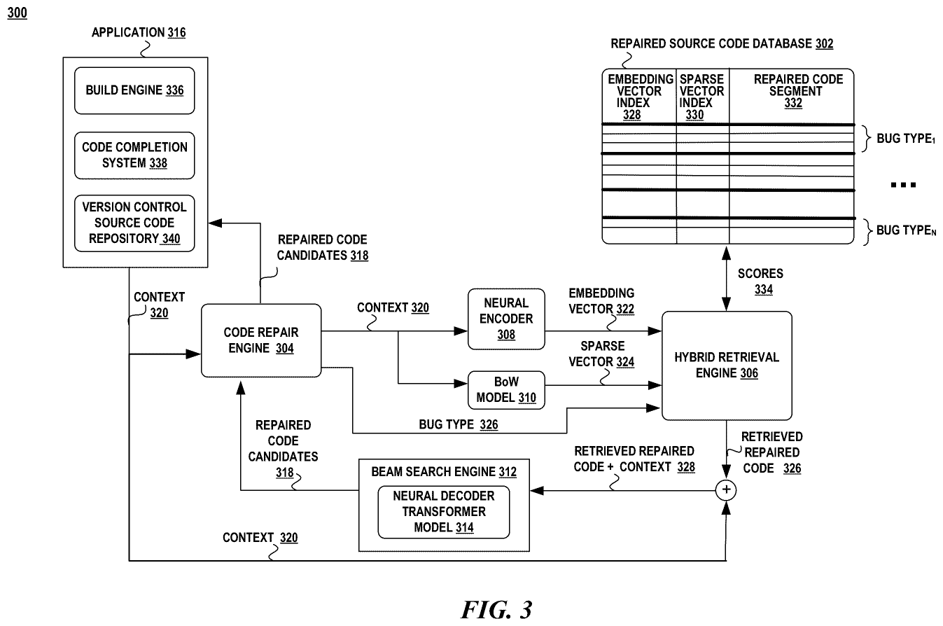

FIG. 3 illustrates a block diagram of an exemplary system 300 in which various aspects of the invention may be practiced. In particular, FIG. 3 illustrates the components used to facilitate source code patch generation. There is shown a repaired source code database 302, a code repair engine 304, a hybrid retrieval engine 306, a neural encoder 308, a BoW model 310, and a beam search engine 312 including a neural decoder transformer model with attention 314. The repaired source code database 302 contains repaired code segments 332 aggregate by a bug type and indexed by an embedding vector index 328 and a sparse vector index 330.

The code repair engine 304 receives a request from an application 316 to obtain repaired code candidates 318. The request includes the context of the source code snippet having an identified bug of a particular bug type at a specified location 320. The code repair engine 304 uses the neural encoder 308 to generate an embedding vector for the context 322 and the Bag-of-Words model 310 to generate a sparse vector 324 given the context 320. The hybrid retrieval engine 306 receives the embedding vector 322, the sparse vector 324 and the bug type 326 and selects the closest retrieved repaired code to the context.

The retrieved repaired code 326 is combined with the context 320 to form an input sequence 328 that is input into the beam search engine 312. The beam search engine 312 uses a neural decoder transformer model 314 to predict one or more repaired code candidates 318 which is returned to the application 316.

In one aspect, the application 316 may be part of a source code version control system 340 where the application automatically checks for bugs in source code pull requests. Upon detection of such a bug, the application 316 generates the context of the buggy source code 320 and sends a request to the code repair engine 304 to generate repaired code candidates 318. The application 316 may alert the author of the pull request of the repaired code candidates 318 or may automatically select one of the repaired code candidates to replace the buggy source code.

In another aspect, the application 316 may be part of a source code editor or integrated development environment that assists developers in the development of a source code program through a code completion system 338. The application 316 may detect a software bug in the source code and send a request to the code repair engine 304 to generate repaired code candidates which are presented to the developer.

In yet another aspect, the application 316 may be part of an automated build engine 336 that automatically tests and builds source code projects into executable and/or image files. The automated build process may detect a software bug in the test phase and request the code repair engine 316 to generate repaired code candidates. The build engine may present the repaired code candidates to the user of the build process or automatically correct the bug with one of the repaired code candidates.

Attention now turns to a more detailed description of the neural transformer models.

### Neural Transformer Models

A neural transformer model with attention is one distinct type of machine learning model. Machine learning pertains to the use and development of computer systems that are able to learn and adapt without following explicit instructions by using algorithms and statistical models to analyze and draw inferences from patterns in data. Machine learning uses different types of statistical methods to learn from data and to predict future decisions. Traditional machine learning includes classification models, data mining, Bayesian networks, Markov models, clustering, and visual data mapping.

Deep learning differs from traditional machine learning since it uses multiple stages of data processing through many hidden layers of a neural network to learn and interpret the features and the relationships between the features. Deep learning embodies neural networks which differs from the traditional machine learning techniques that do not use neural networks. Neural transformers models are one type of deep learning that utilizes an attention mechanism. Attention directs the neural network to focus on a subset of features or tokens in an input sequence thereby learning different representations from the different positions of the tokens in an input sequence. The neural transformer model handles dependencies between its input and output with attention and without using recurrent neural networks (RNN) (e.g., long short-term memory (LSTM) network) and convolutional neural networks (CNN).

It should be noted that the term neural transformer model and neural transformer model with attention are used interchangeably. It should also be noted that the aspects disclosed herein are described with respect to neural transformer model with attention. However, the techniques are not limited to these types of neural networks and can be applied to other types of deep learning models that utilize a neural network with an attention mechanism, such as a memory efficient transformer (e.g., Poolingformer), or an encoder-decoder transformer with multi-head cross-attention.

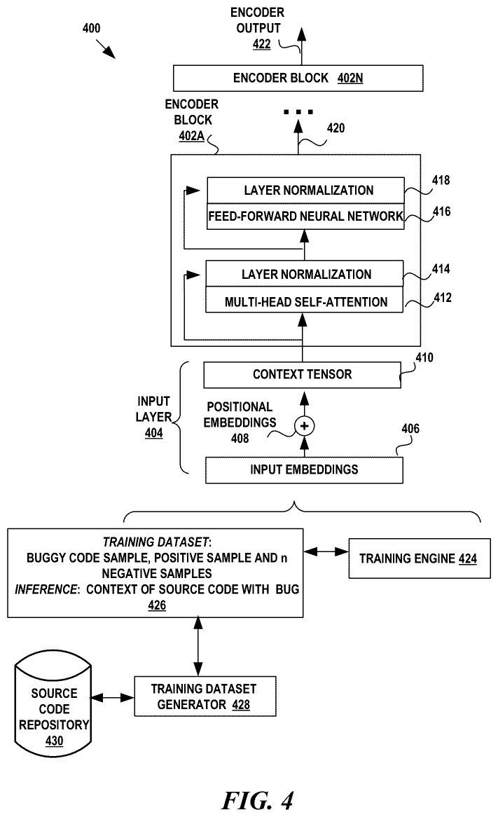

FIG. 4 shows an exemplary structure of the encoder as a neural transformer model with attention in an encoder-only configuration. In an aspect, the encoder is a multi-layer bidirectional neural transformer with attention. It should be noted that the phrases “neural encoder transformer model with attention,” “encoder”, and “neural encoder transformer model” are used interchangeably.

Referring to FIG. 4, the neural encoder model 400 contains one or more encoder blocks 402A-402B (“402”). The input layer 404 to the first encoder block 402A includes an input embedding layer 406 containing embeddings of the input sequence, a positional embedding layer 408, and a context tensor 410. The positional embeddings 408 are used to retain the order of the tokens in the input sequence. The context tensor 410 contains the positional embeddings added to the input embedding 406.

An encoder block 402 consists of two layers. The first layer includes a multi-head self-attention component 412 followed by layer normalization component 414. The second layer includes a feed-forward neural network 416 followed by a layer normalization component 418. The context tensor 410 is input into the multi-head self-attention layer 412 of the encoder block 402 with a residual connection to layer normalization 414. The output of the layer normalization 414 is input to the feed-forward neural network 416 with another residual connection to layer normalization 418. The output of the encoder block 402A is a set of hidden representations 420. The set of hidden representations 420 is then sent through additional encoder blocks, if multiple encoder blocks exist.

Attention is used to decide which parts of the input sequence are important for each token, especially when decoding long sequences since the encoder is limited to encoding a fixed-size vector. Attention mechanisms gather information about the relevant context of a given token and then encode that context into a vector which represents the token. It is used to identity the relationships between tokens in the long sequence while ignoring other tokens that do not have much bearing on a given prediction. As such, the attention component precedes the neural network layer.

The multi-head self-attention component 412 takes a context tensor 410 and weighs the relevance of each token represented in the context tensor 410 to each other by generating attention weights for each token in the input embeddings 406. In one aspect, the attention function is scaled dot-product attention which is described mathematically as follows:

$$Attention ( Q , K , V ) = softmax ( \frac{Q {K}^{T}}{\sqrt{{d}_{k}}} ) V ,$$

where the input consists of queries [symbol] and keys K of dimension dₖ, and values V of dimension d_{ν}. [symbol] is a matrix that contains the query or vector representation of one token in a sequence, K is the vector representations of all tokens in the sequence, and V is the vector representations of all the tokens in the sequence.

The queries, keys and values are linearly projected h times in parallel with d_{ν} output values which are concatenated to a final value:

MultiHead( [symbol] , K, V)=Concat(head₁, . . . , headₕ) W^{o},

where headᵢ=Attention( [symbol] , KWᵢ^{K}, VWᵢ^{V}),

with parameter matrices Wᵢ^{Q}ϵ [symbol] ^{d}^{_{model}}^{×d}^{ₖ}, Wᵢ^{K}ϵ [symbol] ^{d}^{_{model}}^{×d}^{ₖ}, Wᵢ^{V}ϵ [symbol] ^{d}^{_{model}}^{×d}^{ₖ}, and W^{O}ϵ [symbol] ^{hd}^{_{ν}}^{×d}^{_{model}}.

In order to reduce the training time of the neural transformer, layer normalization is used between the layers. The layer normalization component normalizes the inputs across the features. The mean and standard deviation is computed across the feature dimensions. There is a first layer normalization 414 that precedes the feed-forward neural network 416 and a second layer normalization 418 that follows the feed-forward neural network 416.

Training is the process where the model's parameters (i.e., embeddings, weights, biases) are learned from the training dataset. Inference is the process where the model makes predictions given an input sequence of data. The encoder training dataset consists of training samples of the form ( [symbol] , P+, P⁻₁, . . . P⁻ₙ), where Q is the buggy source code snippet of a particular bug type, P+ is the positive sample, and P⁻₁, . . . P⁻ₙ are the n negative samples 426. During inference, the first encoder block of the model receives the context of a buggy source code snippet 426.

The buggy source code snippets [symbol] are extracted from source code files of a source code repository 130 where the commit history shows a change to the source code to correct a software bug. A positive code sample, P+, is a semantically-similar source code segment to the buggy source code snippet, [symbol] . A negative code sample, P−, is a source code segment that is not semantically-similar to the buggy source code snippet. The negative code samples can be randomly selected from unrelated source code.

A semantically-similar source code segment is one that performs the same functionality although syntactically different. Syntactic similarity is based on a similar syntax. However, it should be noted that in some cases, a semantically-similar source code segment may be syntactically similar.

In some situations, positive code samples are not readily available and to generate the positive code samples would require a considerable amount of compilation and execution cost. In order to compensate for this issue, the training engine 424 creates the positive code samples from source code snippets with the same functionality by applying several semantic-preserving transformations to the original source code sample.

In one aspect, identifier renaming and dead code insertion are used to create the positive code samples. Identifier renaming is a method of renaming one identifier with another. In one aspect, variable names and method names are renamed since other identifiers cannot be changed arbitrarily like built-in types or API invocations.

Dead code insertion puts dead source code into a code fragment at a particular location. Dead code is a source code snippet that cannot be reached or is reachable but whose results cannot be used in another computation. In this manner, the altered code is functionally similar to the original source code.

The training dataset 426 is used by the training engine 424 to train the neural encoder 400 to learn to generate embeddings (i.e., embedding vector) so that embeddings of semantically-similar source code snippets are close to each other and embeddings of semantically-dissimilar source code snippets are far apart.

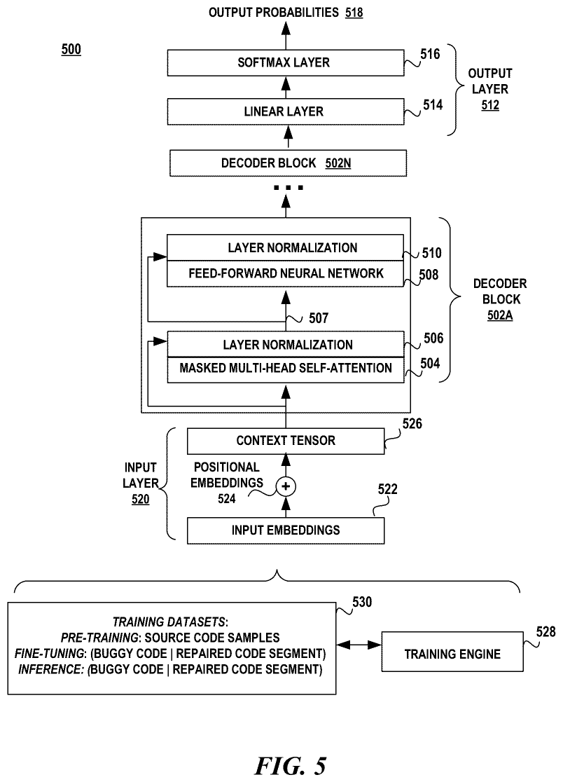

FIG. 5 illustrates an exemplary configuration of an exemplary autoregressive deep learning model. An autoregressive deep learning model is a neural network-based model that predicts future values from past values. In an aspect, the autoregressive deep learning model is a neural decoder transformer model with attention 500. The phrases “neural decoder transformer model with attention”, “decoder”, “decoder model” and “neural decoder transformer model” are used interchangeably.

The neural decoder transformer model 500 includes multiple stacked decoder blocks 502A-502N (“502”). The decoder 500 predicts each token tᵢ in the target language one-by-one at each time step conditioned on all previously-generated target tokens t₁, . . . tᵢ₋₁. Each decoder block 502 consists of two layers. The first layer includes a masked multi-head self-attention component 504 followed by a layer normalization component 506. The output of the layer normalization component 506 is input into the second layer which includes a feed-forward neural network 508 with a residual connection to layer normalization component 510.

The masked multi-head self-attention component 504 receives the output embeddings of the previous timestep. The masked multi-head self-attention component 504 masks the output embeddings from future time steps. The feed-forward neural network 508 processes each output encoding separately. A layer normalization component 506, 510 is used between the layers in order to normalizes the inputs across the features.

The output layer 512 includes a linear layer 514 and a softmax layer 516. The linear layer 514 projects the vector produced by the stack of decoders into a logits vector. The softmax layer 512 then turns the scores of the logits vector into output probabilities for each token in the vocabulary V which are positive and normalized 518.

The input layer 520 to the first decoder block 502A includes an input embedding layer 522 containing embeddings of the input sequence, a positional embedding layer 524, and a context tensor 526. The positional embeddings 524 are used to retain the order of the tokens in the input sequence. The context tensor 526 contains the positional embeddings added to the input embedding 522.

The training engine 528 pre-trains the neural decoder transformer model on source code samples. The training engine 528 then fine-tunes the pre-trained neural decoder transformer model with pairs of training samples where each pair consists of a buggy source code snippet with its corresponding repaired code separated by a separator character. The fine-tuning stage utilizes supervised data, with each sample consisting of a pair: a buggy code snippet with surrounding context and hint, and a corresponding repaired code. Fine-tuning the neural decoder-only transformer model on supervised data, as opposed to continually pretraining on source code samples without the bugs, allows the model to be tailored for a translation task. The translation task is more suitable for the bug fixing as opposed to autoregressive language modeling because it allows the model to attend to the buggy code, as well as the context after the buggy line, rather than just the context preceding the buggy line of code.

During training, the first decoder block 502A receives an initial input embedding 552 that includes a start token, <START> and an input sequence. Thereafter, at each subsequent time step, the input embedding 552 is the output embedding shifted by one token. During inference, the initial input to the first decoder block 504A contains a <START> token and a pair consisting of a bug source code snippet and its repaired code segment counterpart separated by a separator character. At each subsequent time step the input is a shifted sequence of the output embeddings from the previous time step to which the positional embeddings are added forming context tensor 526.

### Methods

Attention now turns to a more detailed description of the methods used in the system for retrieval-augmented code completion. It may be appreciated that the representative methods do not necessarily have to be executed in the order presented, or in any particular order, unless otherwise indicated. Moreover, various activities described with respect to the methods can be executed in serial or parallel fashion, or any combination of serial and parallel operations. In one or more aspects, the method illustrates operations for the systems and devices disclosed herein.

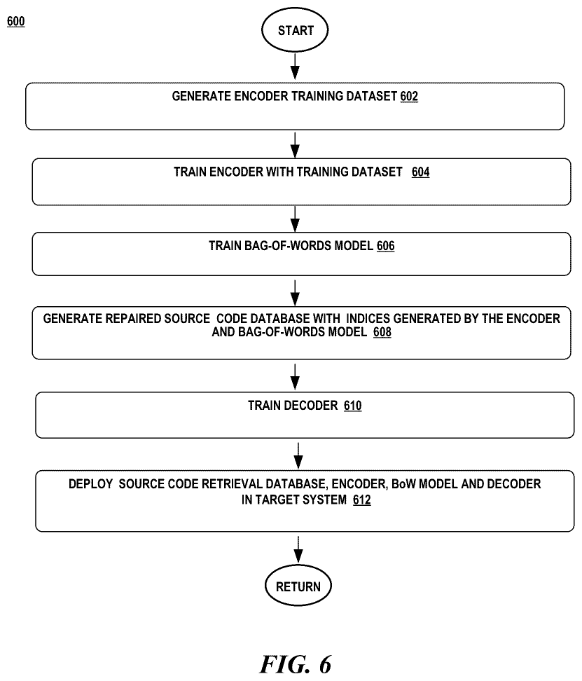

FIG. 6 illustrates an exemplary method 600 for generating the models and database used in the source code patch generation system. The method uses an offline process to generate the training dataset to train the neural encoder transformer model (block 602), to train the neural encoder transformer model with the training dataset (block 604), to train the Bag-of-Words model (block 606), to generate the indices (block 608), to train the neural decoder transformer model (block 610), and to generate the repaired code retrieval database with indices generated by the neural encoder transformer model and the Bag-of-Words model (block 608). Once these components are generated and validated, they are deployed in a target system for real-time processing (block 612).

The neural encoder transformer model is trained through contrastive learning. Contrastive learning is self-supervised learning technique where the model learns from contrasting samples and in particular, the attributes that are common and the attributes that are different from the different types of samples. Given a contrastive pretraining dataset D={qi, pᵢ⁺, p_{i,1}⁻, . . . , p_{i,h}⁻}, i=0 . . . N, where each sample consists of a query having an embedding of a buggy code snippet; a positive sample includes an embedding of a semantically similar buggy code snippet of the same bug type; and a set of negatives samples are irrelevant buggy code snippets of a different bug type or vulnerability-free code snippets. The contrastive loss is then given by the following formula (negative log likelihood of the positive sample):

$$L ( {q}_{i} , {p}_{i}^{+} , {p}_{i , 1}^{-} , … , {p}_{i , n}^{-} ) = - log \frac{{e}^{s i m ( {q}_{i ,} {p}_{i}^{+} )}}{{e}^{sim ( {q}_{i} , {p}_{i}^{+} )} + {\sum }_{i = 1}^{n} {e}^{s i m ( {q}_{i} , {p}_{i , j}^{-} )}} ,$$

where sim is the cosine similarity between the embedding vectors.

Turning to FIGS. 4 and 6, the training dataset generator 428 generates a self-supervised training dataset from various source code files from one or more source code repositories 480. The training dataset 426 includes numerous training samples where each training sample includes a buggy source code snippet, a positive code and n negative codes. In one aspect, the buggy source code snippet is a source code method having a known source code bug. (Collectively, block 602).

The buggy source code snippets are mined from the commit histories of the source code repository or obtained from known datasets of buggy source code, such as Detects4j, etc. The corresponding negative source code is generated by randomly selecting n source code snippets unrelated to the buggy source code snippets. The negative source code snippets may be extracted randomly from the source code repository. (Collectively, block 602).

The positive code represents a semantically-similar source code snippet to the buggy source code snippet. Searching for semantically-similar code is a complex process requiring extensive code compilation and execution costs which is unrealistic for mining a large source code database. In order to overcome this obstacle, transformations are made on the buggy source code snippet to generate the positive code. In one aspect, the transformations include identifier renaming and dead code insertion. (Collectively, block 602).

The training engine 424 then trains the neural encoder transformer model with the training dataset 426. Neural transformer models are trained iteratively, making multiple passes over the training dataset before converging to a minimum. An epoch represents the entire training dataset passed forwards and backwards through the neural transformer block once. Since the training dataset is very large, it is partitioned into smaller batches. The training is iterative and the entire dataset is passed through the neural transformer in multiple iterations. Each training iteration includes forward propagation, loss calculation, backpropagation steps followed by updating the weights. The training dataset 426 is partitioned into batches with each batch of sequences running through the training process. (Collectively, block 604).

The neural encoder transformer model has multiple blocks and layers so that more detailed relationships within the data are learned as well as how the features interact with each other on a non-linear level. The model architecture, training procedure, data normalization and vocabulary encoding procedures are hyperparameters that are tailored to meet a particular objective. The values of the hyperparameters influence how the parameters are learned. (Collectively, block 604).

For each input sequence of each batch in each epoch, the T-ordered sequences of subtokens are then mapped into numeric vectors and then into respective subtoken embeddings and positional embeddings. An embedding is a learned representation for the text-based subtokens where subtokens that have a common meaning have a common representation. An embedding is a mapping of discrete categorical variables to a vector of continuous numbers. There is an embedding for each subtoken in the vocabulary and a corresponding positional embedding. The subtoken embedding represents the learned representation for the subtoken. The neural transformer model does not read each subtoken sequentially and as such, has no knowledge of the subtoken's position in a sequence without additional position information. The positional embedding is used to embed position information about a subtoken's position in a sequence into the neural transformer model. (Collectively, block 604).

Initial values are generated for the subtoken embedding and positional embeddings of each sequence which are then used to form a context tensor. Thereafter, the neural encoder transformer model learns the values for each embedding. Upon the completion of the training phase, the embeddings for each subtoken and the positional embeddings are saved into respective matrices for later use. There is a subtoken embedding matrix, We, that contains an embedding vector for each subtoken tᵢ, i=0 . . . V, and a positional embedding matrix, Wp, that contains an embedding vector Pⱼ, j=0 . . . T, for each position, where V is the size of the vocabulary and T is the length of the subtoken sequence. (Collectively, block 604).

The first encoder block 402A of the neural encoder transformer model takes the context tensor 410 as input and passes it through the multiple layers of multi-head self-attention, layer normalization and feed-forward neural network to finally produce the set of hidden representations If there are additional encoder blocks, the output of each encoder block is passed onto the next encoder block with the output of the last encoder block producing the set of hidden representations. At the end of the training, the encoder learns the embeddings for each token of an input sequence. (Collectively, block 604).

The Bag-of-Words model is trained on the source code tokens that appear in the source code files or segments that will be contained in the retrieval source code database. The Bag-of-Words model is trained by extracting code segments from the source code files of a source code repository and computing the frequency each unique token or n-gram sequence of tokens occurs in a file. Upon completion of the training, the Bag-of-Words model will have built a vocabulary of unique tokens or n-gram sequence of tokens and the frequency of usage of each unique token or n-gram in the collection of source code files. (Collectively, block 606).

Turning to FIGS. 1 and 6, the retrieval source code database 128 is constructed from source code segments having a repair for a software bug. Each repaired code segment is given two indices: an embedding vector index 130 generated by the neural encoder transformer model 118; and a sparse vector index 132 generated by the Bag-of-Words model 120. The embedding vector index 130 and the sparse vector index 132 for each code segment is incorporated into the database 128 (Collectively, block 608).

Turning to FIGS. 5 and 6, the neural decoder transformer model 500 is trained using the training engine 528 to predict the source code tokens of the repaired code. During pretraining, the neural decoder transformer model is optimized following a standard autoregressive language modeling objective. The neural decoder transformer model 500 is pre-trained on unsupervised source code snippets from various source code files in one or multiple programming languages.

The neural decoder transformer model 500 is then fine-tuned by the training engine 528 on a fine-tuning dataset 530 consisting of pairs of data, wherein each pair consists of a buggy source code snippet, a separator character, and the corresponding repaired source code (block 610).

During training, the first decoder block 502A receives an input embedding 522 representing a start token, <START> and the input sequence. Thereafter, the first decoder block takes a shifted sequence of an output embedding as input. The masking in the masked multi-head attention layer is used to prevent positions from attending to subsequent positions in the future. The masking combined with the output embeddings shifted by one position ensures that the predictions to position T depend only on the known outputs at positions less than T. Starting with the first token of the output sequence, the subtokens are passed through the self-attention and normalization layers and into the feed-forward neural network. (Collectively, block 610).

The feed-forward neural networks in the decoder blocks are trained iteratively, making multiple passes over the training dataset before converging to a minimum as noted above with respect to the encoder training. Each training iteration includes forward propagation, loss calculation, backpropagation steps followed by updating the weights by calculating the weight gradients. The loss function estimates the loss or error which is used to compare how good or bad the predicted results are. In one aspect, a categorical cross-entropy loss function is used. Once the loss is calculated, it is propagated backwards to the hidden layer that contributed directly to the output. In backpropagation, the partial derivatives of the loss function with respect to the trainable parameters are determined. The weight gradients are calculated as the difference between the old values and the new values of the weights. The weights are adjusted to make the loss as small as possible using a gradient descent technique. In one aspect, a Stochastic Gradient Descent (SGD) method is the optimization algorithm used to find the values of parameters of the function that minimizes the loss function. A backpropagation through time (BPTT) algorithm may be used to update the weights. (Collectively, block 610).

Attention now turns to a more detailed discussion of the runtime operation of the source code patch generation system.

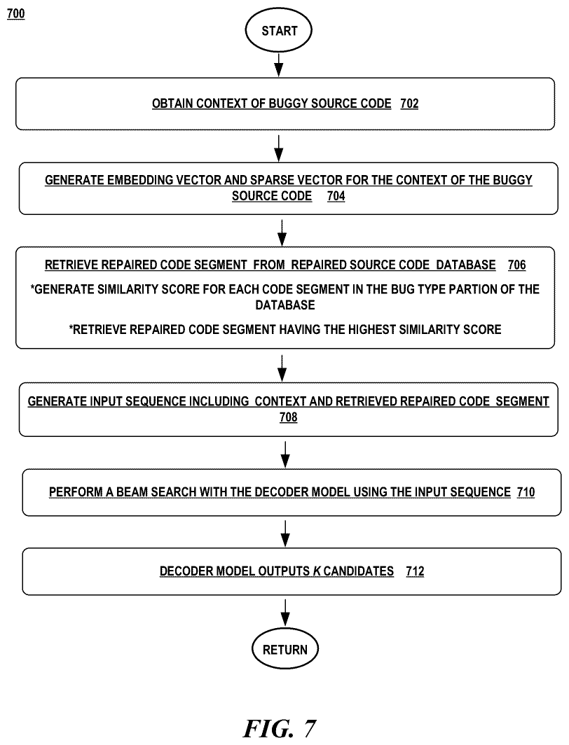

FIG. 7 illustrates an exemplary inference method 700 utilizing the retrieval-augmented process in a source code patch generation system. Referring to FIGS. 3 and 7, an application 316 requests candidates to repair a source code program having an identified bug and bug type. The application 316 generates the context of the buggy source code snippet 320. The buggy source code snippet may be a method, expression, class, or group of program statements. In one aspect, the context of the buggy source code snippet 320 includes a bug type annotation, an extended context, focal and/or peer methods, and the method with the buggy source code with bug location markers. (Collectively, block 702).

The code repair engine 304 receives the context of the buggy source code snippet 320 and generates an embedding vector 322 and a sparse vector 324 from the context. The embedding vector is generated by the neural encoder 308 and the sparse vector is generated by the BoW model 310. (Collectively, block 704).

The hybrid retrieval engine 306 generates a similarity score for each entry in the database. The similarity score is the linear combination of an embedding-based score and a vector-based score. The embedding-based score may be computed as the dot product between embedding vectors as follows: sim (q, c)=E(c)^{T} E(q), where q is the context, c is the source code segment in the retrieval database, E(c)^{T} is the transpose of the embedding vector index for an entry in the retrieval source code database, and E(q) is the embedding vector for the context of the buggy source code snippet. (Collectively, block 704).

The hybrid retrieval engine 306 generates a score based on the Bag-of-Words vector of the context of the buggy source code snippet using a term-frequency based computation. In one aspect, the score may be computed using a Best Matching 25 (“BM25”) algorithm which is as follows:

$${\sum }_{i}^{n} IDF ( {q}_{i} ) \frac{f ( {q}_{i} , D ) * ( k 1 + 1 )}{f ( {q}_{i} , D ) + k 1 * ( 1 - b + b * \frac{field L e n}{avgFieldLen} )} \qquad ( 1 )$$

where q is the query or buggy source code snippet of length n,

qᵢ is the i-th source code token of the query,

IDF (qᵢ) is the inverse document frequency of qᵢ,

D is a buggy source code snippet,

ƒ(qᵢ, D) is the frequency that qᵢ appears in source code file D,

k1 is a variable that determines the term frequency saturation,

b is a variable that affects the length ratio,

fieldLen is the length of a source code file, and

avgFieldLen is the average length of all the source code files.

Both scores for each entry in the retrieval source code database is combined and the entry having the highest score is selected. (Collectively, block 706).

The context 320 and the retrieved repaired code segment 326 are concatenated to form an input sequence that is transmitted to the beam search engine 312 (block 708).

The beam search engine 312 uses a beam search to predict the most likely candidate to repair the buggy code. A beam search iteratively generates tokens/subtokens by invoking the neural decoder transformer model 314. The output of the neural decoder transformer model 314 is a matrix of token probabilities for each position in a candidate sequence. The beam search engine 312 concentrates on the k most probable tokens at each iteration to get the best path to the most likely candidate sequence. At each iteration, each of the k most probable tokens are concatenated with the tokens in the preceding iterations to form a partial candidate sequence. (Collectively, block 710).

A beam search uses a breadth-first search to build a search tree. The search tree is composed of nodes at one or more inference levels. Each node represents a probability distribution generated by the neural decoder transformer model for the tokens/subtokens in the model vocabulary. At each level, only the top k tokens/subtokens having the highest probabilities from the output distribution generated by the neural decoder transformer model are expanded to the next inference level. The variable k is preconfigured and also referred to as the beam width. Each of the k subtokens/tokens is then expanded into a search that updates the current context sequence with the selected subtoken/token to input into the neural decoder transformer model to generate an additional probability distribution for the next token in a sequence. This process is repeated until an end-of-sequence token is predicted as being the next likely token candidate. (Collectively, block 710).

Upon the completion of the beam search, the code repair engine 304 receives the top k repaired code candidates 318 likely to repair the buggy source code which is sent back to the application 316 (block 712).

### Exemplary Operating Environment

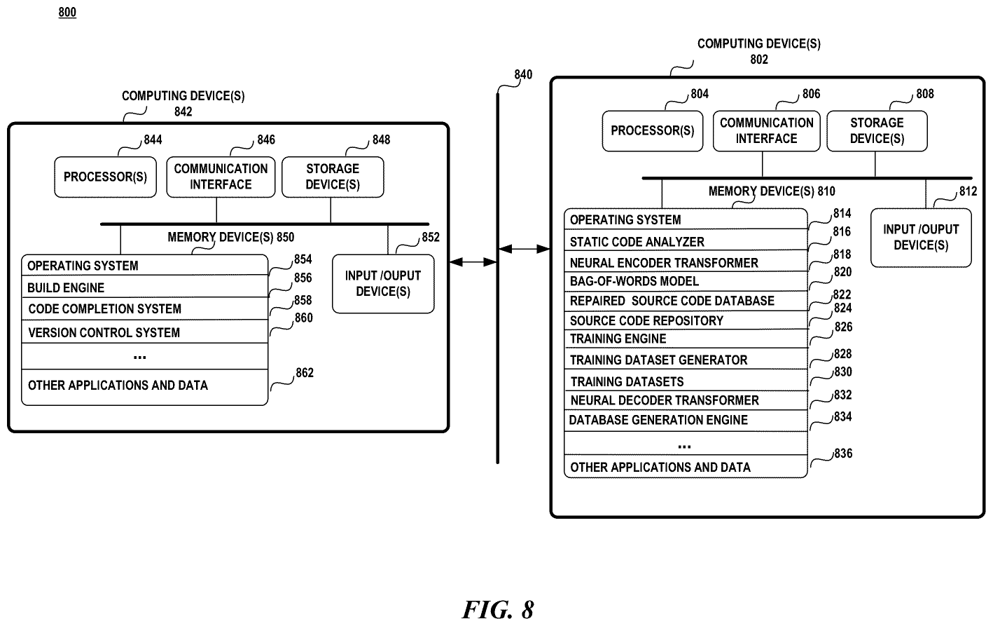

Attention now turns to a discussion of an exemplary operating environment 800. FIG. 8 illustrates an exemplary operating environment 800 in which one or more computing devices 802 are used to develop the models and database of the source code patch generation system and another set of computing devices 842 that utilize the source code patch generation system to generate repaired code. However, it should be noted that the aspects disclosed herein is not constrained to any particular configuration of the computing devices. In another aspect, a single computing device may be configured to develop the components of the source code patch generation system and perform the real-time source code patch generation repair.

A computing device 802, 842 may be any type of electronic device, such as, without limitation, a mobile device, a personal digital assistant, a mobile computing device, a smart phone, a cellular telephone, a handheld computer, a server, a server array or server farm, a web server, a network server, a blade server, an Internet server, a work station, a mini-computer, a mainframe computer, a supercomputer, a network appliance, a web appliance, a distributed computing system, multiprocessor systems, or combination thereof. The operating environment 700 may be configured in a network environment, a distributed environment, a multi-processor environment, or a stand-alone computing device having access to remote or local storage devices.

A computing device 802, 842 may include one or more processors 804, 844, one or more communication interfaces 806, 846, one or more storage devices 808, 848 one or more memory devices or memories 810, 850, and one or more input/output devices 812, 852. A processor 804, 844 may be any commercially available or customized processor and may include dual microprocessors and multi-processor architectures. A communication interface 806, 846 facilitates wired or wireless communications between the computing device 802, 842 and other devices. A storage device 808, 848 may be computer-readable medium that does not contain propagating signals, such as modulated data signals transmitted through a carrier wave. Examples of a storage device 808, 848 include without limitation RAM, ROM, EEPROM, flash memory or other memory technology, CD-ROM, digital versatile disks (DVD), or other optical storage, magnetic cassettes, magnetic tape, magnetic disk storage, all of which do not contain propagating signals, such as modulated data signals transmitted through a carrier wave. There may be multiple storage devices 808, 848 in the computing devices 802, 842. The input/output devices 812, 852 may include a keyboard, mouse, pen, voice input device, touch input device, display, speakers, printers, etc., and any combination thereof.

A memory device or memory 810, 850 may be any non-transitory computer-readable storage media that may store executable procedures, applications, and data. The computer-readable storage media does not pertain to propagated signals, such as modulated data signals transmitted through a carrier wave. It may be any type of non-transitory memory device (e.g., random access memory, read-only memory, etc.), magnetic storage, volatile storage, non-volatile storage, optical storage, DVD, CD, floppy disk drive, etc. that does not pertain to propagated signals, such as modulated data signals transmitted through a carrier wave. A memory 810, 850 may also include one or more external storage devices or remotely located storage devices that do not pertain to propagated signals, such as modulated data signals transmitted through a carrier wave.

A memory device 810, 850 may contain instructions, components, and data. A component is a software program that performs a specific function and is otherwise known as a module, program, and/or application. The memory device 810 may include an operating system 814, a static code analyzer 816, a neural encoder transformer 818, a Bag-of-Words model 820, a repaired source code database 822, a source code repository 824, a training engine 826, a training dataset generator 828, training datasets 830, a neural decoder transformer model 832, a database generation engine 834, and other applications and data 836.

The memory device 850 may include an operating system 854, a build engine 856, a code completion system 858, a version control system 860, and other applications and data 862.

A computing device 802, 842 may be communicatively coupled via a network 840. The network 840 may be configured as an ad hoc network, an intranet, an extranet, a virtual private network (VPN), a local area network (LAN), a wireless LAN (WLAN), a wide area network (WAN), a wireless WAN (WWAN), a metropolitan network (MAN), the Internet, a portion of the Public Switched Telephone Network (PSTN), plain old telephone service (POTS) network, a wireless network, a WiFi® network, or any other type of network or combination of networks.

The network 840 may employ a variety of wired and/or wireless communication protocols and/or technologies. Various generations of different communication protocols and/or technologies that may be employed by a network may include, without limitation, Global System for Mobile Communication (GSM), General Packet Radio Services (GPRS), Enhanced Data GSM Environment (EDGE), Code Division Multiple Access (CDMA), Wideband Code Division Multiple Access (W-CDMA), Code Division Multiple Access 2000, (CDMA-2000), High Speed Downlink Packet Access (HSDPA), Long Term Evolution (LTE), Universal Mobile Telecommunications System (UMTS), Evolution-Data Optimized (Ev-DO), Worldwide Interoperability for Microwave Access (WiMax), Time Division Multiple Access (TDMA), Orthogonal Frequency Division Multiplexing (OFDM), Ultra Wide Band (UWB), Wireless Application Protocol (WAP), User Datagram Protocol (UDP), Transmission Control Protocol/Internet Protocol (TCP/IP), any portion of the Open Systems Interconnection (OSI) model protocols, Session Initiated Protocol/Real-Time Transport Protocol (SIP/RTP), Short Message Service (SMS), Multimedia Messaging Service (MMS), or any other communication protocols and/or technologies.

### Technical Effect

Aspects of the subject matter disclosed herein pertain to the technical problem of generating a source patch generation system that operates with reduced computing resources while maintaining a high accuracy level. The technical feature associated with addressing this problem is the augmentation of a hint to the context of a buggy source code snippet that is used by a neural decoder transformer model to predict the most likely repaired code candidate to repair the buggy source code snippet. The hint is a source code segment that is semantically-similar to the buggy source code snippet based on a context that includes a bug type annotation, an extended context, focal/peer methods, and/or the method of the buggy source code with location markers.

The technical effect achieved is the reduction of the training corpus needed by the neural decoder transformer model to achieve a high level of accuracy. Training on a large corpus of samples increases the accuracy of the model but increasing the number of parameters used by the model and its size. A large sized model requires additional computing resources to train and deploy. The addition of the hint provides the model with guidance on making its predictions with without requiring the additional training and deployment cost.

### Conclusion

A system is disclosed comprising: one or more processors; and a memory that stores one or more programs that are configured to be executed by the one or more processors. The one or more programs include instructions to perform actions that: obtain context of a buggy source code snippet having an identified bug and an identified bug type, wherein the context includes a method containing the buggy source code snippet with location markers surrounding source code containing the identified bug and the identified bug type; search for a repaired code segment for the buggy source code snippet in a retrieval source code database, wherein the repaired source code database includes a plurality of repaired code segments, wherein a repaired code segment includes a source code segment having been repaired for a software bug, wherein each repaired source code segment is associated with a bug type; select the repaired code segment having a closest similarity to a context of the buggy source code snippet, wherein the selected repaired code segment is associated with a same bug type as the identified bug type; and generate a candidate to repair the buggy source code snippet from an autoregressive deep learning model given the context of the buggy source code snippet and the selected repaired code segment.

In an aspect, the one or more programs include instructions to perform actions that: encode the context of the buggy source code snippet in an embedding vector and a sparse vector. In an aspect, each repaired code segment is associated with an embedding vector index and a sparse vector index, wherein the embedding vector index and the sparse vector index are based on a context of a respective repaired code segment. In an aspect, the one or more programs including instructions to perform actions that: select the repaired code segment based on the embedding vector of the context of the buggy source code snippet and the sparse vector of the context of the buggy source code snippet closely matching the embedding vector index and the sparse vector index of the selected repaired source code segment.

In an aspect, the embedding vector is generated by a neural encoder, and the sparse vector is generated by a term-frequency encoder. In an aspect, the neural encoder is a neural encoder transformer model with attention. In an aspect, the autoregressive deep learning model includes a neural decoder transformer model with attention. In an aspect, the context of the buggy source code snippet includes an extended context, a focal method and/or a peer method. In an aspect, the context of the buggy source code snippet is obtained from a version-controlled source code repository. In an aspect, the context of the buggy source code snippet is obtained from a build process or a code completion system.

A computer-implemented method is disclosed, comprising: providing a retrieval source code database, wherein the retrieval source code database includes a plurality of repaired code segments, each of the plurality of repaired code segments associated with a bug type; receiving a context of a buggy source code snippet, wherein the context includes an identified bug type of the buggy source code snippet and location markers surrounding the buggy source code snippet; searching for a repaired code segment from the retrieval source code database based on the context of the buggy source code snippet having a same bug type as the identified bug type; and generating source code to repair the buggy source code snippet from an autoregressive deep learning model given the context of the buggy source code snippet and the retrieved code segment.

In an aspect, the computer-implemented method further comprises: constructing an embedding vector from the context of the buggy source code snippet and a sparse vector from the context of the buggy source code snippet. In an aspect, the computer-implemented method further comprises: associating an embedding vector index and a sparse vector index for each of the retrieved code segments. In an aspect, the computer-implemented method further comprises: searching for the repaired code segment from the retrieval source code database using the embedding vector and the sparse vector of the buggy source code snippet.

In an aspect, the computer-implemented method further comprises: computing a similarity score for each of the plurality of repaired code segments of the retrieval source code database based on a similarity of the embedding vector index and the sparse vector index with respect to the embedding vector and the sparse vector of the buggy source code snippet.

In an aspect, the computer-implemented method further comprises: receiving the context of the buggy source code snippet from a version-controlled source code repository. In an aspect, the computer-implemented method further comprises: receiving the context of the buggy source code snippet from a code completion system. In an aspect, the computer-implemented method further comprises: receiving the context of the buggy source code snippet from a build engine. In an aspect, the embedding vector from the context of the buggy source code snippet is generated from a neural encoder transformer with attention and the sparse vector from the context of the buggy source code snippet is generated from a Bag-of-Words model. In an aspect, the autoregressive deep learning model is a neural decoder transformer with attention.

Although the subject matter has been described in language specific to structural features and/or methodological acts, it is to be understood that the subject matter defined in the appended claims is not necessarily limited to the specific features or acts described above. Rather, the specific features and acts described above are disclosed as example forms of implementing the claims.

It may be appreciated that the representative methods described herein do not necessarily have to be executed in the order presented, or in any particular order, unless otherwise indicated. Moreover, various activities described with respect to the methods can be executed in serial or parallel fashion, or any combination of serial and parallel operations.

What is claimed:

1. A system comprising:
one or more processors; and
a memory that stores one or more programs that are configured to be executed by the one or more processors, the one or more programs including instructions to perform actions that:
obtain context of a buggy source code snippet having an identified bug and an identified bug type, wherein the context includes a method containing the buggy source code snippet with location markers surrounding source code containing the identified bug and the identified bug type;
search for a repaired code segment for the buggy source code snippet in a retrieval source code database, wherein the repaired source code database includes a plurality of repaired code segments, wherein a repaired code segment includes a source code segment having been repaired for a software bug, wherein each repaired source code segment is associated with a bug type;
select the repaired code segment having a closest similarity to a context of the buggy source code snippet, wherein the selected repaired code segment is associated with a same bug type as the identified bug type; and
generate a candidate to repair the buggy source code snippet from an autoregressive deep learning model given the context of the buggy source code snippet and the selected repaired code segment.

2. The system of claim 1, wherein the one or more programs include instructions to perform actions that:
encode the context of the buggy source code snippet in an embedding vector and a sparse vector.

3. The system of claim 2, wherein each repaired code segment is associated with an embedding vector index and a sparse vector index, wherein the embedding vector index and the sparse vector index are based on a context of a respective repaired code segment.

4. The system of claim 3, wherein the one or more programs including instructions to perform actions that:
select the repaired code segment based on the embedding vector of the context of the buggy source code snippet and the sparse vector of the context of the buggy source code snippet closely matching the embedding vector index and the sparse vector index of the selected repaired source code segment.

5. The system of claim 2, wherein the embedding vector is generated by a neural encoder, and
wherein the sparse vector is generated by a term-frequency encoder.

6. The system of claim 5, wherein the neural encoder is a neural encoder transformer model with attention.

7. The system of claim 1, wherein the autoregressive deep learning model includes a neural decoder transformer model with attention.

8. The system of claim 1, wherein the context of the buggy source code snippet includes an extended context, a focal method and/or a peer method.

9. The system of claim 1, wherein the context of the buggy source code snippet is obtained from a version-controlled source code repository.

10. The system of claim 1, wherein the context of the buggy source code snippet is obtained from a build process or a code completion system.

11. A computer-implemented method, comprising:
providing a retrieval source code database, wherein the retrieval source code database includes a plurality of repaired code segments, each of the plurality of repaired code segments associated with a bug type;
receiving a context of a buggy source code snippet, wherein the context includes an identified bug type of the buggy source code snippet and location markers surrounding the buggy source code snippet;
searching for a repaired code segment from the retrieval source code database based on the context of the buggy source code snippet having a same bug type as the identified bug type; and
generating source code to repair the buggy source code snippet from an autoregressive deep learning model given the context of the buggy source code snippet and the retrieved code segment.

12. The computer-implemented method of claim 11, further comprising:
constructing an embedding vector from the context of the buggy source code snippet and a sparse vector from the context of the buggy source code snippet.

13. The computer-implemented method of claim 12, further comprising:
associating an embedding vector index and a sparse vector index for each of the retrieved code segments.

14. The computer-implemented method of claim 13, further comprising:
searching for the repaired code segment from the retrieval source code database using the embedding vector and the sparse vector of the buggy source code snippet.

15. The computer-implemented method of claim 14, further comprising:
computing a similarity score for each of the plurality of repaired code segments of the retrieval source code database based on a similarity of the embedding vector index and the sparse vector index with respect to the embedding vector and the sparse vector of the buggy source code snippet.

16. The computer-implemented method of claim 11, further comprising:
receiving the context of the buggy source code snippet from a version-controlled source code repository.

17. The computer-implemented method of claim 11, further comprising:
receiving the context of the buggy source code snippet from a code completion system.

18. The computer-implemented method of claim 11, further comprising:
receiving the context of the buggy source code snippet from a build engine.

19. The computer-implemented method of claim 11, wherein the embedding vector from the context of the buggy source code snippet is generated from a neural encoder transformer with attention and the sparse vector from the context of the buggy source code snippet is generated from a Bag-of-Words model.

20. The computer-implemented method of claim 11, wherein the autoregressive deep learning model is a neural decoder transformer with attention.
